(19) United States
(12) Patent Application Publication
(10) Pub. No.: US 2010/0009323 A1
(43) Pub. Date: Jan. 14, 2010

(54) Simulation Software System and Method of Implementing The Same

(76) Inventors: Chuan-Lang Lin, Kaohsiung (TW); Hsiu-Feng Huang, Kaohsiung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/169,048

(22) Filed: Jul. 8, 2008

(51) Int. Cl. G09B 19/00

(52) U.S. Cl. 434/219

(57) ABSTRACT

A simulation software system includes a training module, a display device and a storage device. Events of a training material, operation blocks, response blocks and response images are provided in the storage device. A method of implementing the simulation software includes the steps of: defining a first of the events via the operation block and defining a second of the events via the response block; defining a response image or a series of response images depending upon the defined events, displaying the response image in the response block; judging whether the first and the second of the events have been completely defined; generating a training module from the first and the second of the events; connecting the training module with a human-machine interface and an abnormity/error-processing module.

### BACKGROUND OF THE INVENTION

1. Field of the Invention

The present invention relates to a simulation software system and a method of implementing the simulation software. More particularly, the present invention relates to the simulation software system for various machines or equipments and the method of implementing the simulation software.

2. Description of the Related Art

Various programmed operating systems or machines such as semiconductor testing apparatuses, semiconductor sorters or cash registers are well known to a person skilled in the art, and are widely used in the semi-automatic control. There exist a lot of commands of operational sequences for various machines. Hence, there is also a need of learning and memorizing all of the commands for the operators prior to operating the machines. In General, new operators must be well trained to learn all of the commands before practically operating the machines. In addition to this, senior operators must also be periodically retrained in order to reduce a possibility of occurring error in routine operation.

Conventionally, a real machine are used in a training course such that trainees are trained and practiced by personally and directly operating the real machine. Accordingly, new trainees can be trained to realize how to operate the machine by means of the practical training, and senior operators can also be retrained in the same way. With regard to the problematic aspects naturally occurring during utilizing the real machine in the practical training course, it requires burdening a large amount of machine cost and providing a number of trainers for demonstrating operation. Another problem with the use of the real machine is the difficulty in avoiding trainee's errors which may cause a machine breakdown. Hence, there is a need of reducing the cost of the real machines for the practical training course and saving the time in practical training.

To reduce a possibility of machine breakdown in practical training, there is another most common training method for the operators. In this training method the trainer must repeatedly display a number of training slides or training materials for correctly operating a machine or the like in each and every the training course. Also, while displaying the training slides and the teaching materials, the trainer must repeatedly explain all of the commands and the situations during conducting error commands in every training course. Hence, there is also a need of saving the time of the trainer for explaining how to operate the machine.

### SUMMARY OF THE INVENTION

The primary objective of this invention is to provide a simulation software system and a method for implementing the simulation software. The simulation software can be executed to simulate an operating panel of a predetermined machine and various situations performed in the predetermined machine. Accordingly, the present invention is successful in saving the training cost and the training time.

Another objective of this invention is to provide a method for implementing a simulation software. The simulation software can be used to execute several tests of various operating sequences of a simulated machine.

Another objective of this invention is to provide a simulation software system connected with a database which is used to store training data for evaluation.

Another objective of this invention is to provide a simulation software which is used to simulate an operating sequences of a semiconductor processing/testing equipment or a cash register.

The method of the simulation software executed on a computer information system in accordance with an aspect of the present invention includes the steps of:

providing a plurality of events of a training material;

providing an operation block and a response block on a display device;

defining a first of the events via the operation block and defining a second of the events via the response block;

defining a response image or a series of response images depending upon the defined events, displaying the response image in the response block;

judging whether the first and the second of the events have been completely defined;

generating a training module from the first and the second of the events;

connecting the training module with a human-machine interface.

In a separate aspect of the present invention, the training module is utilized to simulate operational steps of using a remote control for controlling household appliances or using an instrument panel for controlling a large-sized machine.

In a further separate aspect of the present invention, the response images are displayed in sequence.

In a yet further separate aspect of the present invention, the training module further connects with an abnormity/error-processing module.

The simulation software system in accordance with another aspect of the present invention includes a training module, a display device and a storage device. A plurality of events of a training material, a plurality of operation blocks, a plurality of response blocks and a plurality of response images are provided in the storage device, and are defined to generate the training module. The training module includes a display control module to display the events, the operation blocks, the response blocks and the response images on the display device. The training module further connects with a human-machine interface.

In a separate aspect of the present invention, the simulation software system is utilized to simulate operational steps of using a remote control for controlling household appliances or an instrument panel for controlling a large-sized machine.

In a yet further separate aspect of the present invention, the response images are displayed in sequence.

In a yet further separate aspect of the present invention, the training module further connects with an abnormity/error-processing module.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a flow chart of a method of implementing a simulation software in accordance with a preferred embodiment of the present invention;

FIG. 2 is a schematic view of a simulation software system displaying operation blocks and response blocks on a display screen in accordance with the preferred embodiment of the present invention; and

FIG. 3 is a block diagram of the simulation software system connected with a human-machine interface in accordance with the preferred embodiment of the present invention.

### DETAILED DESCRIPTION OF THE INVENTION

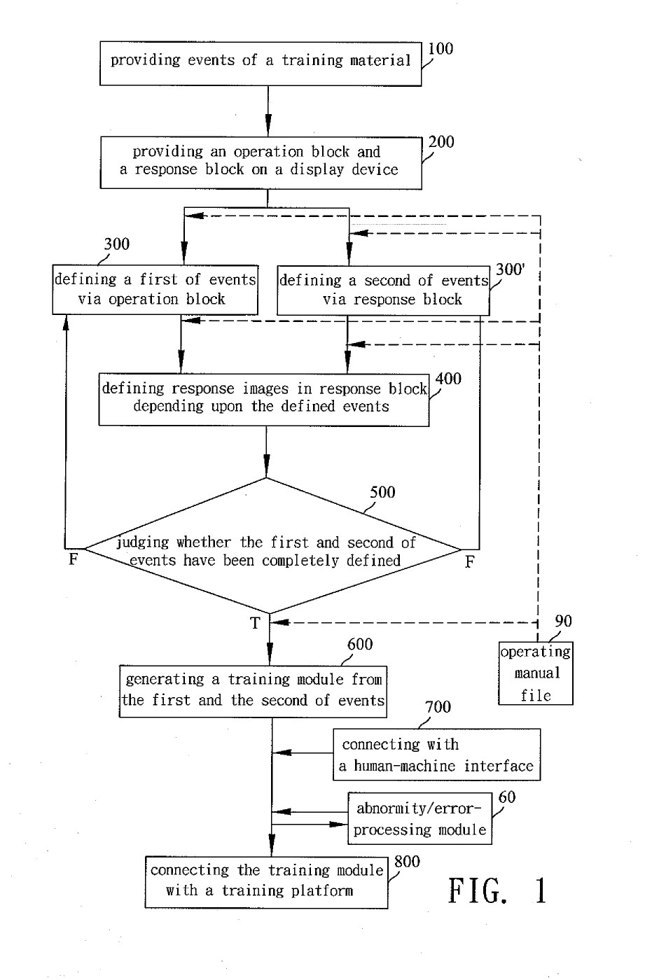

Referring now to FIG. 1, a flow chart of a method of implementing a simulation software in accordance with a preferred embodiment of the present invention is shown. The method of the present invention is executed on a computer information system to implement the simulation software as a training material for use in an e-learning program of human resource office or product promotion department. In a preferred embodiment, the simulation software in accordance with the present invention can be used to simulate operational interfaces of programmed operating machines such as semiconductor-testing machines or semiconductor-sorting machines. In another preferred embodiment, the simulation software in accordance with the present invention can be used to simulate operational steps of using a remote control for controlling household appliances or an instrument panel for controlling a large-sized machine. The computer information system includes a display device (not shown in FIG. 1) to display the training material while executing the simulation software of the present invention.

With continued reference to FIG. 1, the method of the present invention includes the steps of: providing a plurality of events of a training material (identified as step 100); providing an operation block and a response block on a display device (identified as step 200); defining a first of the events via the operation block (identified as step 300) and defining a second of the events via the response block (identified as step 300′); defining a response image or a series of response images in the response block depending upon the defined events (identified as step 400); judging whether the first and the second of the events have been completely defined (identified as step 500); generating a training module from the first and the second of the events (identified as step 600); connecting the training module with a human-machine interface (identified as step 700). In a preferred embodiment, the training module is further connected with a training platform (identified as step 800).

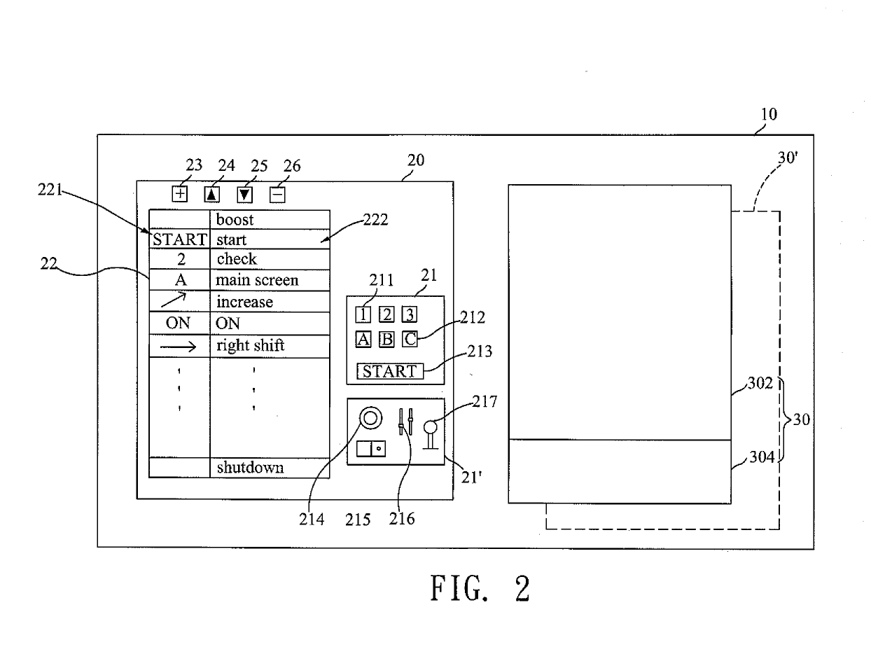

Turning now to FIG. 2, a schematic view of a simulation software system displaying the operation block 20 and the response block 30 on a display screen is shown. Referring to FIGS. 1 and 2, in step 100, a plurality of the events of the training material are provided. Preferably, each event of the training material represents a single operational step or a set of operational steps.

Still referring to FIGS. 1 and 2, in step 200, a display screen 10 of the display device arranged in the computer information system is utilized to display the operation block 20 and the response block 30. Accordingly, a user can select and define the events of the operation block 20 and the response block 30 shown on the display device. Preferably, the display device may be a LCD display, a plasma display or other equivalent displays. The computer information system is selected from a workstation, a personal computer, a laptop computer or other equivalent computer devices.

Prior to defining the operation block 20 and the response block 30, the computer information system can link an operating manual file 90, as best shown in FIG. 1. Preferably, users can open and read the operating manual file 90 in whichever step. In a preferred embodiment, the operating manual file 90 is selected from a specification file, an image file or a multimedia file.

Still referring to FIG. 2, the operation block 20 is used to display a series of the events, and includes an event-defining box 22 and a plurality of icons 23-26. The event-defining box 22 is used to show a menu of codes 221 and a code conversion list 222. Preferably, the menu of codes 221 is provided with a scrollbar. The icons 23-26 can be selected by clicking a cursor thereon in adjusting a procedure of the events. In a preferred embodiment, the icon 23 represents a function of “ADD”, the icon 24 represents a function of “DOWN”, the icon 25 represents a function of “UP”, and the icon 26 represents a function of “DELETE”. In addition, the procedure of the events can be adjusted by directly selecting and dragging without the need of operating the icons 23-26.

Still referring to FIG. 2, the response block 30 includes a response image area 302 and a specification display area 304. In a preferred embodiment, the response image area 302 is used to display response images corresponding to the events of the training material. For example, the digital camera technology may be used to capture the response images. In a preferred embodiment, the specification display area 304 is used to display a specification file, an image file or a multimedia file for specifying the corresponding response images displayed in the response image area 302.

Still referring to FIGS. 1 and 2, in step 300, a first of the events is defined via the operation block 20, and in step 300′, a second of the events defined via the response block 30. At least operational interface images 21 and 21′ are shown in the operation block 20. The operational interface images 21 and 21′ are selected from a machine panel image, a remote control panel image or a dashboard image which may be a digital image. The operational interface images 21 and 21′ may include a plurality of control component images 211-217. For instance, numeral button images are designated numeral 211, letter button images are designated numeral 212, command button images are designated numeral 213, a knob image is designated numeral 214 and a switch image is designated numeral 215. Clicking the control component images 211-217 can represent simulation of operating these control components.

In step 300, two of the operational interface images 21 and 21′ shown in the in the operation block 20 are determined by defining the first of the events of the training material. Correspondingly, in step 300′, the operation block 20 and the response blocks 30 and 30′ can be also switched by defining the second of the events of the training material. In a preferred embodiment, the operational interface images 21 and 21′ can be used to define the first and second of the events of the training material. In the present embodiment, the codes 221 and the corresponding code conversion list 222 shown in the operation block 20 are used to illustrate a procedure of the first and second of the events. For instance, the defined events of the training material include a procedure of “START”, “2”, “A”, [symbol] “ON”, “→”. . . . Accordingly, the code “START” represents an operation of clicking a button of “START” (identified as 213), the code “2” represents an operation of clicking a button of “2” (identified as 211), the code “A” represents an operation of clicking a button of “A” (identified as 212), the code [symbol] represents an operational direction of turning a knob (identified as 214), the code “ON” represents an operation of actuating a switch (identified as 215), and the code [symbol] represents an operational direction of moving a joystick (identified as 217). In this manner, the defined events of the training material are a simulation procedure of starting, checking, entering a main screen, increasing, right shifting and so forth.

In steps 300 and 300′, the defined codes 221 and the corresponding code conversion list 222 are shown in the event-defining box 22 while operating the operational interface image 21. In a preferred embodiment, the control component images 211-217 are marked properly.

Still referring to FIGS. 1 and 2, in step 400, a response image or a series of response images are defined depending upon the defined events shown in the operation block 20, and are shown in the response image area 302 of the response block 30 or 30′. In a preferred embodiment, the response block 30 is only shown on the display device according to defining the second of the events. Additionally, when the simulation software system is applied as a training material, the response image area 302 can display the results of operation in training.

Still referring to FIGS. 1 and 2, in step 500, the simulation software system must be operated to judge whether the first and the second of the events have been completely defined. If the first and the second of the events are completely defined, the simulation software system can allow executing next steps. If not the simulation software system requires returning one or both of steps 300, 300′, and executing steps 300, 300′ and 400 again. In step 600, the defined events, the corresponding response images and the corresponding specification display areas are prepared to generate a training module. In training, the training module can be performed as an interactive computer file for training or testing.

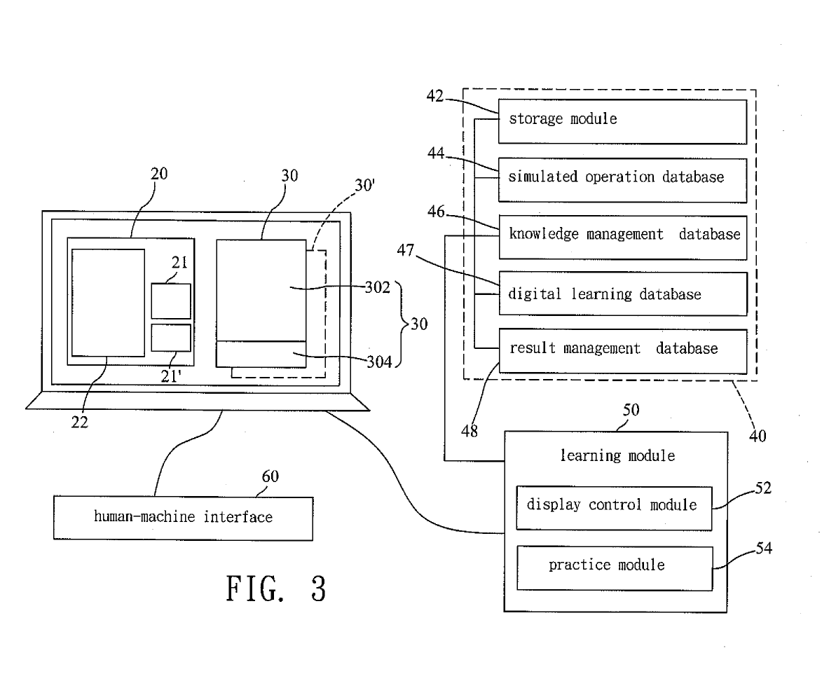

Turning now to FIG. 3, a block diagram of the simulation software system connected with a human-machine interface in accordance with the preferred embodiment of the present invention is shown. Referring to FIGS. 1 through 3, in step 700, the training module is connected with a human-machine interface, as best shown in FIG. 3, such that the operator can operate the training module via the human-machine interface for training or testing. Preferably, the human-machine interface may be selected from an exterior device, including a joystick, a mouse, a keyboard, an instrument panel, an operating panel, a touch screen or other equivalent devices. In a preferred embodiment, the training module is further connected with an abnormity/error-processing module. The abnormity/error-processing module can notice the user any error occurring during operation. In step 800, the training module is further connected with a training platform to form the simulation software system.

Referring again to FIG. 2, in another preferred embodiment, the display device is formed with a touch screen area such that the operator can directly operate the interactive computer files displayed in the operation block 20 and the response block 30 via the touch screen area.

Referring to FIG. 3, the simulation software system in accordance with the present invention further includes a storage device 40 and a learning module 50. The storage device 40 includes a storage module 42, a simulated operation database 44, a knowledge management database 46, a digital learning database 47 and a result management database 48. The learning module 50 includes a display control module 52 and a practice module 54. In training, the learning module 50 is executed to display the events stored in the storage device 40 so as to store various information in the simulated operation database 44, the knowledge management database 46, the digital learning database 47 and the result management database 48.

With continued reference to FIG. 3, the simulation software system in accordance with the present invention further includes an abnormity/error-processing module 60. Once the training module is generated, the training module connects with the abnormity/error-processing module 60 which can provide messages of abnormity/error or warning in training. In a preferred embodiment, the abnormity/error-processing module 60 is connected with the storage device 40 so as to store the knowledge management database 46 or the result management database 48.

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. A method of implementing the simulation software, comprising the steps of:
providing a plurality of events of a training material;
providing an operation block and a response block;
defining a first of the events via the operation block and defining a second of the events via the response block;
defining at least one response image or a series of response images depending upon the first and the second of the defined events, and displaying the response image in the response block;
judging the first and the second of the events being completely defined;
generating a training module from the first and the second of the events; and
connecting the training module with a human-machine interface.

2. The method as defined in claim 1, wherein providing the operation block and the response block on a display device.

3. The method as defined in claim 1, wherein the training module is utilized to simulate operational steps of using a remote control for controlling a household appliance or using an instrument panel for controlling a large-sized machine.

4. The method as defined in claim 1, wherein the response images are displayed in sequence.

5. The method as defined in claim 1, further comprising the step of: the training module connecting with an abnormity/error-processing module.

6. A simulation software system, comprising:
a plurality of events of a training material, a plurality of operation blocks, a plurality of response blocks and a plurality of response images being provided in a storage device;
a first of said events being defined via the operation block, and a second of said events being defined via the response block;
at least one of the response image being defined depending upon the first and the second of the defined events, and the defined response image is displayed in the response block;
a training module being generated, said training module is connected with a human-machine interface.

7. The simulation software system as defined in claim 6, wherein the training module is utilized to simulate operational steps of using a remote control for controlling a household appliance or using an instrument panel for controlling a large-sized machine.

8. The simulation software system as defined in claim 6, wherein the operation block and the response block are displayed on a display device.

9. The simulation software system as defined in claim 6, wherein the training module connects with an abnormity/error-processing module.
